(19) United States
(12) Patent Application Publication
(10) Pub. No.: US 2004/0160899 A1
(43) Pub. Date: Aug. 19, 2004

(54) Device for observing network packets

(75) Inventors: Kuen-Chu Lai, DaLi City (TW); Shih-Ping Hsieh, HsinChu City (TW); Pa Hsuan, Taipei City (TW); Jian-Bang Yeh, ChangHua City (TW); Kuan-Seng Ng, Bukit Mertajam Pulau Pinang (MY)

Correspondence Address: Ladas & Parry, 26 West 61st Street, New York, NY, 10023, US

(73) Assignee: W-CHANNEL INC.

(21) Appl. No.: 10/628,665

(22) Filed: Jul. 28, 2003

(30) Foreign Application Priority Data
Feb. 18, 2003 (TW) 092202514

(51) Int. Cl. H04L 12/26

(52) U.S. Cl. 370/252

(57) ABSTRACT

A device for observing variations of network packets comprises a first observer device, a second observer device, and third observer device for analyzing contents of the packets; a first, second, and third hubs for transmitting the packets; a first, second, and third packet extractors each having a packet outputting end and a packet receiving end. The packet receiving end of the first packet extractor is connected to the first, second, and third hubs. The packet outputting end of the first packet extractor is connected to the first observer device. The packet receiving end of the second packet extractor is connected to the first, second, and third hubs. The packet outputting end of the second packet extractor is connected to the second observer device. The packet receiving end of the third packet extractor is connected to the first hub, second, and third hubs. The packet outputting end of the third packet extractor is connected to the third observer device.

### BACKGROUND OF THE INVENTION

1. Field of the Invention

This invention generally relates to the field of network application. More particularly, the present invention relates to a device for observing the network packet operation.

2. Description of the Prior Art

Normally, data would be divided into several blocks according to applicable communication protocols before being transmitted via networks. These data blocks are called packet because they are treated as being packeted.

The data transmission is actually achieved by many packets via the networks, wherein each packet has a destination address and a source address to avoid getting lost during transmission. Thus, packets transmitted to a particular IP address is able to pass through multiple routers and switches.

A user cannot observe packet variations as the packets pass through the network nodes. As a result, a device for observing the network packets is needed.

### SUMMARY OF THE INVENTION

In accordance with the present invention, a device for observing the operation of the network packets is provided. According to the present invention, the user can observe variations as packets pass through network nodes or are handshaken by way of heterogeneous network protocols.

Accordingly, an object of the present invention is to observe packets at hubs and handshaking phenomena between different network protocols.

Another object of the present invention is to observe data variations of the packets when the packets pass through different hubs.

According to the present invention, a device for observing the variation of network packets comprises a first I/O observer device, a second I/O observer device, and third I/O observer device for analyzing the contents of packets; a first hub, a second hub, and a third hub for transmitting the packets and; a first packet extractor, a second packet extractor, and a third packet extractor respectively having a packet outputting end and a packet receiving end, wherein the packet receiving end of the first packet extractor is simultaneously connected to the first hub, the second hub, and the third hub, and the packet outputting end of the first packet extractor is connected to the first I/O observer device. The packet receiving end of the second packet extractor simultaneously to the first hub, the second hub, and the third hub. The packet outputting end of the second packet extractor is connected to the second I/O observer device. The packet receiving end of the third packet extractor is simultaneously connected to the first hub, the second hub, and the third hub. The packet outputting end of the third packet extractor is connected to the third I/O observer device.

The I/O observer device is used to analyze the contents of the packets. The foregoing purpose can be fulfilled by a general personal computer. The packet extractor can be a general network interface card used in the personal computer for receiving and extracting the packets via the hubs.

### BRIEF DESCRIPTION OF THE DRAWINGS

The foregoing aspects and many of the attendant advantages of this invention reference to the following detailed description, when taken in conjunction with the accompanying drawings, wherein:

FIG. 1 is a preferred embodiment of the present invention.

### DESCRIPTION OF THE PREFERRED EMBODIMENT

One embodiment of the invention will now be described in greater detail. Nevertheless, it should be noted that the present invention can be practiced in a wide range of other embodiments besides this embodiment explicitly described, and the scope of the present invention is expressly not limited except as specified in the accompanying claims.

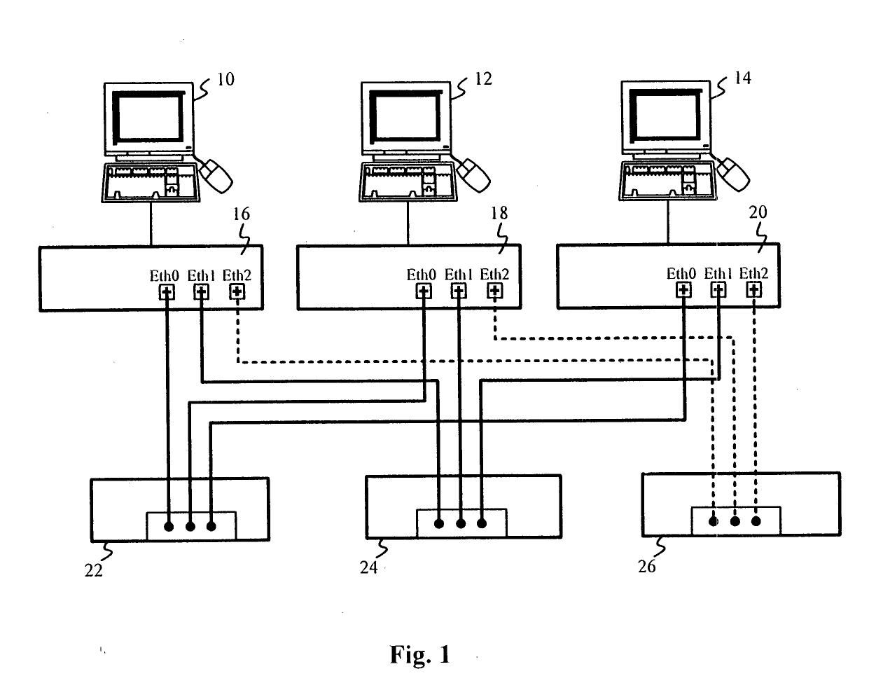

FIG. 1 is the preferred embodiment of the present invention, wherein a first I/O observer device 10, a second I/O observer device 12, and a third I/O observer device 14 are used for analyzing a packet. In this preferred embodiment, a personal computer is used as the I/O observer device for observing variations as the packet passes through a network node or after network handshaking. However, the present invention is may also employ other apparatus having the same packet analyzing function in other embodiments.

Referring, to FIG. 1, a first hub 22 is simultaneously connected to a first packet extractor 16, a second packet extractor 18, and a third packet extractor 20. A second hub 24 is also simultaneously connected to the first packet extractor 16, the second packet extractor 18, and the third packet extractor 20. A third hub 26 is also simultaneously connected to the first packet extractor 16, the second packet extractor 18, and the third packet extractor 20. In accordance with the above-mentioned connecting relationship, a network is formed. Further, the hubs are allowed to connect various types of communication protocols, such as wireless network or IP v6 for separating different kind of networks.

As shown in FIG. 1, the first packet extractor 16 passes the packet extracted from the network to the first I/O observer device 10 and thereby analyzes the extracted packet. The I/O second observer device 12 and the third I/O observer device 14 are respectively connected to the second packet extractor 18 and the third packet extractor for observing and analyzes the extracted packets.

In this preferred embodiment, the packet extractors can be three network interface cards respectively mounted in three personal computers and connected with the hubs 22, 24, 26. In addition, the hubs 22, 24, 26 are also connected to other network interface cards mounted in other computers, so as to form a network environment.

According to the above, the first I/O observer device 10 receives the packets transmitted via the network, which comprises the hubs 22, 24, 26. The first I/O observer device 10 may obtain the packets from the first hub 22, the second hub 24, and the third hub 26 to observe the data variation as the packets pass through the hubs, the packets may be data packets generated with various network applications and protocols, for examples, packets enerated for applying to Firewall, Virtual Private Network (VPN), Tunneling, Network Address Translation (NAT), IP sharing, and Routing Protocol.

In addition, the second I/O observer device 12 and the third I/O observer device 14 extract in the same way the packets transmitted via the first hub 22, the second hub 24, and the third hub 26, to observe the data variation as the packets pass through different the hubs.

According to the above, the present invention provides an observation device for observing data variation of the observed packets, which caused by various network applications or different protocol handshaking. The observation devices of the present invention may be implemented three I/O observer devices, as illustrated in the preferred embodiment, or more than three observer devices or personal computers, to observe the packet operation of a large scale network.

Although specific embodiments have been illustrated and described, it will be obvious to those skilled in the art that various modifications may be made without departing from what is intended to be limited solely by the appended claims.

What is claimed is:

1. A device for observing variations of network packets, comprising:
a first I/O observer device for analyzing contents of a packet;
a second I/O observer device for analyzing contents of a packet;
a third I/O observer device for analyzing contents of a packet;
a first hub for transmitting the packets;
a second hub for transmitting the packets;
a third hub for transmitting the packets;
to a first packet extractor having a packet outputting end and a packet receiving end, wherein said packet receiving end of the first packet extractor is connected to said first hub, said second hub, and third hub, and said packet outputting end of the first packet extractor is connected to said first I/O observer device;
a second packet extractor having a packet outputting end and a packet receiving end, wherein said packet receiving end of the second packet extractor is connected to said first hub, said second hub, and third hub, and said packet outputting end of the second packet extractor is connected to said second I/O observer device; and
a third packet extractor having a packet outputting end and a packet receiving end, wherein said packet receiving end of the third packet extractor is connected to said first hub, said second hub, and third hub, and said packet outputting end of the third packet extractor is connected to said third I/O observer device.

2. The device for observing variations of network packets according to claim 1, wherein said first I/O observer device is a personal computer.

3. The device for observing variations of network packets according to claim 1, wherein said second I/O observer device is a personal computer.

4. The device for observing variations or network packets according to claim 1, wherein said third I/O observer device is a personal computer.

5. The device for observing variations of network packets according to claim 2, wherein said first packet extractor comprises three network interface cards respectively connected to said first hub, said second hub, and said third hub.

6. The device for observing variations of network packets according to claim 3, wherein said second packet extractor comprises three network interface cards respectively connected to said first hub, said second hub, and said third hub.

7. The device for observing variations of network packets according to claim 4, wherein said third packet extractor comprises three network interface cards respectively connected to said first hub, said second hub, and said third hub.

8. A device for observing network packets, comprising
a first hub;
a second hub;
a third hub;
a first personal computer provided with at least three network interface cards respectively connected to say first hub, said second hub, and said third hub;
a second personal computer provided with at least equips with three network interface cards respectively connected to said first hub, said second hub, and said third hub; and
a third personal computer provided with at least three network interface cards respectively connected to said first hub, said second hub, and said third hub.
